(19) United States
(12) Patent Application Publication
(10) Pub. No.: US 2010/0095301 A1
(43) Pub. Date: Apr. 15, 2010

(54) METHOD FOR PROVIDING SERVICE IN PERVASIVE COMPUTING ENVIRONMENT AND APPARATUS THEREOF

(75) Inventors: Youngho SUH, Gwangju (KR); Hyoungsun Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/572,365

(22) Filed: Oct. 2, 2009

(30) Foreign Application Priority Data
Oct. 9, 2008 (KR) 10-2008-0099112

(51) Int. Cl. G06F 9/50

(52) U.S. Cl. 718/104

(57) ABSTRACT

Provided is a method for providing a service in a pervasive computing environment that extracts a service type which can be provided by a resource searched in the corresponding environment and when a service type to be executed is selected in an application, the corresponding resource is allocated to the selected service to allow the corresponding application to execute the service by utilizing the allocated resource. Further, the allocated resource is locked and the corresponding resource is unlocked upon a request of another application.

### RELATED APPLICATIONS

The present application claims priority to Korean Patent Application Serial Number 10-2008-0099112, filed on Oct. 9, 2008, the entirety of which is hereby incorporated by reference.

### BACKGROUND OF THE INVENTION

1. Field of the Invention

The present invention relates to a method for providing services in a pervasive computing environment and an apparatus thereof, and more particularly, to a method for providing services in a pervasive computing environment and an apparatus thereof that can prevent resource conflicts between services when a number of service applications are executed concurrently by a number of multiple users.

2. Description of the Related Art

In general, studies on resource conflicts or concurrency control in a computer system or a distributed system have been conducted in a field such as an operating system, a database, etc. for a long time and various solutions thereof have been proposed.

However, studies for concurrency control and for solving resource conflicts in a pervasive computing environment have not actively progressed.

Recently, several research institutions have started the studies. For example, there is proposed a conflict resolution method based on a sealed-bid auction method in order to solve conflicts by a context-aware mobile application or a method of solving conflicts by analyzing context histories of a number of multiple users a context history of each of the users to extract preferences of the users in order to solve conflicts when a number of applications are used at the same time while running a context aware application in a smart home environment. A method for dynamically solving the conflict in a context-aware application environment where the plurality of users or a method for preventing various conflict phenomena which may occur between the applications by specifying the interdependent relationship between pervasive computing applications on the basis of ambient calculus is proposed by taking into consideration of a user's preference in addition to a user's intent.

However, such a study has a limit in three aspects.

First, since one integrated model for targets that collide with each other, additional conflict description, conflict detection, and conflict resolution are required for each case. Second, since a binding of the pervasive computing applications and a resource using the applications are not dynamically generated, occurrence of the conflict and a solution thereof are also static and limitative. Lastly, a user API is not provided in which an application developer who develops the pervasive computing application can expect the conflict that may occur and can describe a solution for the occurrence of the conflict while preparing the application.

### SUMMARY OF THE INVENTION

An object of the present invention is to provide a method for providing services in a pervasive computing environment and an apparatus thereof that can solve conflicts of the same resource, which may occur when a number of service applications are executed concurrently by a number of multiple users in the pervasive computing environment.

In order to achieve the above-mentioned objects, according to an exemplary embodiment of the present invention there is a method for providing services in a pervasive computing environment, which includes a resource manager, a service manager, and an application, that includes searching a resource usable in the corresponding computing environment and register the resource in the service manager by the resource manager; receiving a request for allocation of a resource corresponding to a service model selected by the application from the service manager; allocating the requested resource to a service configured based on the corresponding service model in receiving the request; and locking or unlocking the allocated resource.

In locking or unlocking the resource, the resource manager locks the corresponding resource upon the request of the application that receives the service to which the resource is allocated while the allocating the request resource. In locking or unlocking the resource, the resource manager selectively locks or unlocks the resources allocated to the service.

Meanwhile, in locking or unlocking the resource, when the resource allocated to the corresponding service is locked, the resource manager selectively unlocks the resource allocated to the corresponding service upon a request of another application and the resource manager allocates the unlocked resource to a service requested by another application.

Further, the method for providing the services in the pervasive computing environment further includes allowing configuring a resource model defined by the resource searched in the corresponding computing environment, wherein information on the resource registered in the service manager includes identification information on the resource model. Further, the resource searched by the resource manager includes at least one of the physical resources and logical resources that exist in the corresponding computing environment.

Meanwhile, in order to achieve the above-mentioned objects, according to another exemplary embodiment, a method for providing services in a pervasive computing environment, which includes a resource manager, a service manager, and an application, that includes allowing the service manager to extract a service type which can be provided by using resource information searched by the resource manager in the corresponding environment and configure a service model having the extracted service type; when a service model to be executed is selected by providing information on the service model to the application, configuring a service of a type corresponding to the selected service model; and providing the services to the corresponding application by being allocated with a resource corresponding to the selected service model from the resource manager, wherein the resource allocated in the providing the services is locked or unlocked by the resource manager.

The service model includes one or more resource information of a required resource required for executing the corresponding service, an optional resource which can be possessed by the corresponding service, and a shared resource of the corresponding service. Further, the method further includes extracting the resource information from the selected service model; and requesting the resource manager to allocate the corresponding resource on the basis of the extracted resource information, before the providing the services.

Meanwhile, in order to achieve the above-mentioned objects, according to a further exemplary embodiment of the present invention, there is an apparatus of providing services in a pervasive computing environment, which includes a resource manager, a service manager, and an application, wherein the resource manager includes an approach manager that allocates a resource to the corresponding service upon a request for allocating a resource corresponding to a service model selected by the application from the service manager and a lock manager that locks or unlocks the resource allocated to the corresponding service by the approach manager.

When there is a request for locking or unlocking a specific resource from the service manager, the lock manager locks or unlocks the corresponding resource. The resource manager 300 includes a resource container 310 in which the resource model for the resource existing in the environment is registered.

The resource manager registers the resource information searched in the corresponding computing environment in the service manager and the resource information registered in the service manager includes identification information on the resource model defined by the resource searched in the corresponding computing environment. The resource model corresponds to one or more service model and the service model includes one or more resource information of a required resource required for executing the corresponding service, an optional resource which can be possessed by the corresponding service, and a shared resource of the corresponding service.

Meanwhile, the resource allocated to the service includes one or more resource of the physical resources and logical resource that exist in the corresponding computing environment.

According to exemplary embodiments, a pervasive computing environment is divided into three hierarchies, i.e., an application hierarchy, a service hierarchy, and a resource hierarchy. Herein, the pervasive computing applications that exist in the application hierarchy share services that exist in a lower hierarchy and the service hierarchy shares and uses resources that exist in a lower hierarchy, thereby modeling all conflict targets by using the service as an individual, i.e., the resource.

By locking resources allocated to a service in the corresponding computing environment, it is possible to prevent the corresponding resources from being conflicted when a number of multiple users use the service. In addition, by unlocking dynamically locked resources, it is possible to share the corresponding resource, whereby the users can use a number of services by granting concurrency to necessary resources on a locking basis.

### BRIEF DESCRIPTION OF THE DRAWINGS

FIG. 1 is a hierarchical configuration diagram illustrating a configuration of a system applied to a service providing apparatus according to an exemplary embodiment;

FIG. 2 is a diagram illustrating a configuration of a service manager applied to a service providing apparatus according to an exemplary embodiment;

FIG. 3 is a diagram illustrating a configuration of a resource manager applied to a service providing apparatus according to an exemplary embodiment;

FIGS. 4 to 5B are diagrams illustrating an operation of a service providing apparatus according to an exemplary embodiment; and

FIGS. 6 to 7 are flowcharts for illustrating an operational flow of a service providing method according to an exemplary embodiment.

### DESCRIPTION OF THE PREFERRED EMBODIMENTS

Hereinafter, exemplary embodiments of the present invention will be described with reference to the accompanying drawings.

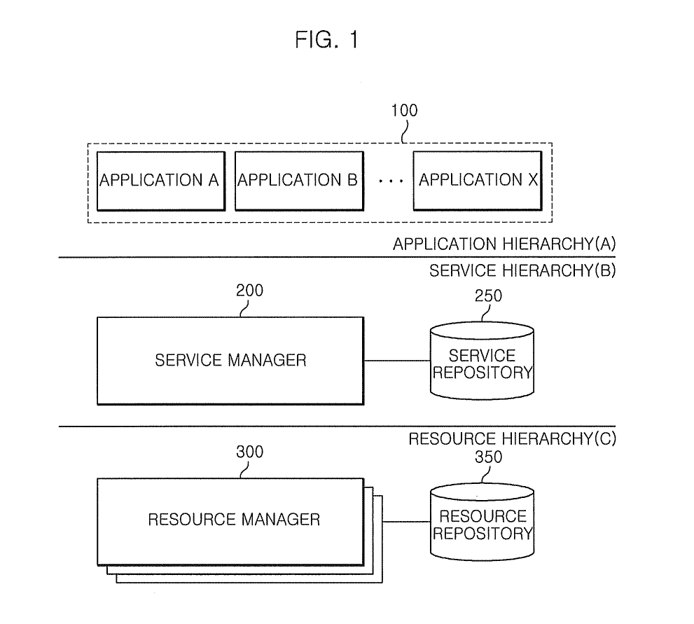

FIGS. 1 to 3 are diagrams illustrating a configuration of a service providing apparatus in a pervasive computing environment according to an exemplary embodiment.

The service providing apparatus in the pervasive computing environment according to the exemplary embodiment solves conflicts of the same resource which occurs due to a plurality services when the same resource is requested from the plurality of services that are provided while one or more application 100 is executed by a user in the pervasive computing environment.

FIG. 1 is a diagram illustrating a structure of an internal system of the service providing apparatus in the pervasive computing environment according to the exemplary embodiment. As shown in FIG. 1, the service providing apparatus according to the exemplary embodiment operates in a state in which a system structure in the pervasive computing environment is divided into three hierarchies, i.e., an application hierarchy A, a service hierarchy B, and a resource hierarchy C. At this time, the application hierarchy A is a higher hierarchy than the service hierarchy B and the service hierarchy B is a higher hierarchy than the resource hierarchy C.

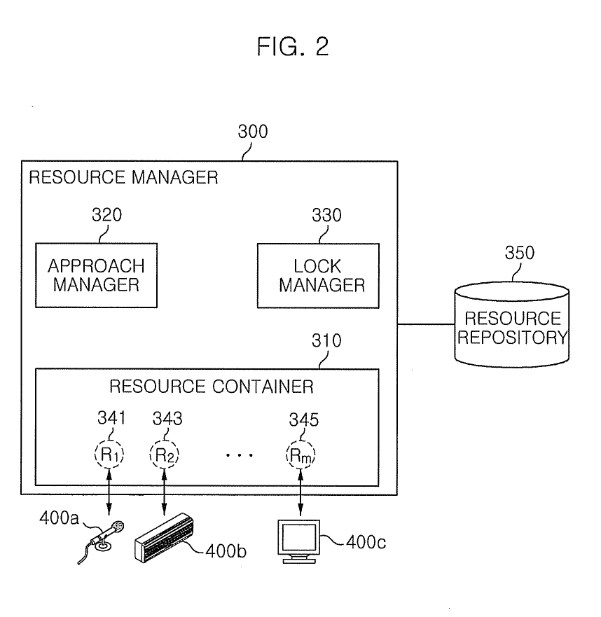

First, a number of resource managers 300 that manage at least one resource exist in the resource hierarchy C and resource information collected by each of the resource managers 300 is stored in a resource repository 350. The resource manager 300 models various types of resources existing in an environment as a type that can be usable in the corresponding environment. At this time, the capability provided by the corresponding resource, an event generated by the resource, etc. are described by a resource description language in each of the resource models. A number of resource models existing in the resource hierarchy C are provided to the service hierarchy B. Hereinafter, a detailed configuration of the resource hierarchy C will be described with reference to FIG. 2.

In the service hierarchy B, a number of service information provided in the environment are stored in a service repository 250 and a service manager 200 that manages the plurality of service information stored in the service repository 250 exists. The service manager 200 receives information on the resource models from the resource manager 300 of the resource hierarchy C. At this time, the service manager 200 combines the resource models registered in the resource hierarchy C to model services usable in the corresponding environment. A required resource required for the corresponding service, an optional resource possessed by the corresponding service, a shared resource shared by the corresponding service, etc. are described by a service description language in each service model.

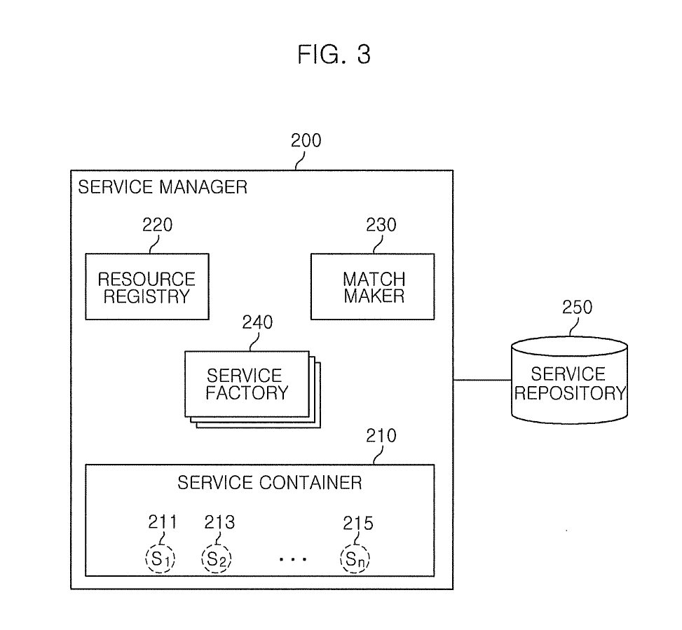

The service models existing in the service hierarchy B are provided to the application hierarchy A. Further, when any one service model is selected by the application hierarchy A, the service manager 200 generates a service corresponding to the selected service to provide the corresponding service to the application hierarchy A in the service hierarchy B. Hereinafter, a detailed configuration of the service hierarchy B will be described with reference to FIG. 3.

A number of applications (application A, application B, . . . , application X) exist in the application hierarchy A which is the highest hierarchy and each of the applications 100 are executed by a number of multiple users. Each application 100 provides the service provided in the service hierarchy B to the users. At this time, the service provided to the users is provided by utilizing at least one resource existing in the resource hierarchy C.

Meanwhile, while each application 100 existing in the application hierarchy A provides the service to the users by utilizing at least one resource existing in the resource hierarchy C, it is possible to lock or unlock the resource utilized in the corresponding service. Accordingly, it is possible to solve the conflict of the resource which occurs while various services are provided to the users in the pervasive computing environment according to the exemplary embodiment.

FIGS. 2 and 3 are diagrams illustrating the configuration of the service providing apparatus according to the exemplary embodiment.

First, FIG. 2 is a diagram illustrating a configuration of a resource hierarchy according to an exemplary embodiment of the present invention. Referring to FIG. 2, the resource manager 300 that manages the resources existing in the environment exists in the resource hierarchy C. The resources existing in the environment include a physical resource corresponding to an existent hardware device such as a microphone, an air-conditioner, a display, a sensor, an actuator, etc. and a non-existent logical resource such as a moving space, a sound space, an information space, etc.

The resource manager 300 includes a resource container 310 in which the resource model for the resource existing in the environment is registered. The resource manager 300 models the logical resource by wrapping the logical resource, i.e., an abstracted resource object to identify the abstracted resource object as one resource and registers the corresponding resource model in the resource container 310. In addition, the resource manager 300 maps the physical resources such as a microphone 400a, a speaker 400b, and a monitor 400c as the logical resource by wrapping the corresponding resource objects, and registers resource models of the corresponding logical resource, i.e., ‘R1 341 ’, R2 343′, . . . , ‘Rm 345 ’ in the resource container 310. The resource manager 300 manages a life cycle for the resource model registered in the resource container 310. If the resource in the corresponding environment is changed, the resource manager 300 notifies information on the changed resource to the service manager 200.

Information on the resource model registered in the resource container 310 is stored in the resource repository 350. At this time, the information on each resource model includes a resource specification.

Meanwhile, the resource manager 300 further includes an approach manager 320 that allocates a resource corresponding to the resource model required in generating the service by the service manager 200 of the service hierarchy B and a lock manager 330 that locks the resource allocated by the approach manager 320.

Whenever the lock manager 330 receives a request from the application 100 of the application hierarchy A, the lock manager 330 can set up of the locking function for the corresponding resource and automatically set up the locking function in allocating the resource in the approach manager 320. Further, the lock manager 330 can release the set-up of the locking function upon the request of the application 100.

Meanwhile, the approach manager 320 can unlock the resource allocated to the corresponding service when there is a request for unlocking the allocated resource to a specific service from the service manager 200 of the service hierarchy B. At this time, the approach manager 320 may unlock only some resources allocated to the corresponding service. Accordingly, it is possible to solve the conflict of the resource by setting up the locking function for a resource allocated to one service to prevent the corresponding resource from being repetitively allocated to another service. Further, when a resource that has been already allocated to another service is used, another service may share the corresponding resource by releasing the locking function set-up to the corresponding resource by mutual consent of service users.

FIG. 3 is a diagram illustrating a configuration of a service hierarchy according to an exemplary embodiment of the present invention. Referring to FIG. 3, the service repository 250 in which information on the services is stored exists in the service hierarchy B. At this time, the information on each service includes a service specification. The service manager 200 that manages the services stored in the service repository 250 exists in the service hierarchy B. At this time, the service manager 200 manages the service which can be provided by the resource models registered by the resource manager 300 in FIG. 2. Herein, one service manager 200 exists in one computing environment.

The service manager 200 includes a resource registry 220 that collects resource specifications for the resource models existing in the corresponding environment from the resource repository 350 of the resource hierarchy C and a match maker 230 that searches the information on the services usable in the corresponding environment by comparing the resource specification collected by the resource registry 220 with the service specification stored in the service repository 250. At this time, the resource specification collected in the resource registry 220 includes an identifier for each resource model.

The service manager 200 generates a service factory 240 for each service type on the basis of the service information searched by the match maker 230. Meanwhile, the service manager 200 models the service object for each type by using the service information searched by the match maker 230 and registers the corresponding service models, i.e., ‘S1 211″S2 213 ’, . . . , ‘Sn 215 ’ in the service container 210. At this time, each service model corresponds to the corresponding service factory 240. The service manager 200 manages a life cycle for each service model registered in the service container 210. If the change of the resource information usable in the corresponding environment is notified from the resource manager 300 of the resource hierarchy C, the service manager 200 changes the service model of the type usable in accordance with the changed resource information.

Meanwhile, when any one application 100 is selected in the application hierarchy A, the service manager 200 receives a request for the service information of the type usable in the corresponding environment from the application 100 selected by the user. At this time, the service manager 200 provides the information on the service model, which is registered in the service container 210 to the corresponding application 100. Herein, the service manager 200 prepares a list of the service models as the information on the service model to the list to the corresponding application 100.

Further, when any one service model is selected by the corresponding application 100, the service manager 200 generates the corresponding type service through the service factory 240 corresponding to the selected service model. At this time, since the required resource required for performing the corresponding service, the optional resource which can be possessed by the corresponding service, the shared resource shared by the corresponding service, etc. are described by a service description language in each service model, the service factory 240 requests the resource manager 300 of the resource hierarchy C to allocate the resource corresponding to the corresponding resource in accordance with the information described in the service model.

The service factory 240 is bound to the corresponding resource by the resource manager 300 to generate the corresponding type service. The service manager 200 provides the service generated by the service factory 240 to the corresponding application 100 and thus, the corresponding application 100 provides the service to the user by using the allocated resource. At this time, the service factory 240 may generate a new service every time or may share one service as a singleton. The service factory 240 can designate the one service for each service type.

Accordingly, the application 100 in the pervasive computing environment can dynamically inquire into a service type usable in the environment through the service manager 200 existing in the corresponding environment and can dynamically generate a desired service through the service factory 240 or obtain the generated service. Such a generated service is managed by the service manager 200 and the generated service and the resources required in generating the service are dynamically bound with each other.

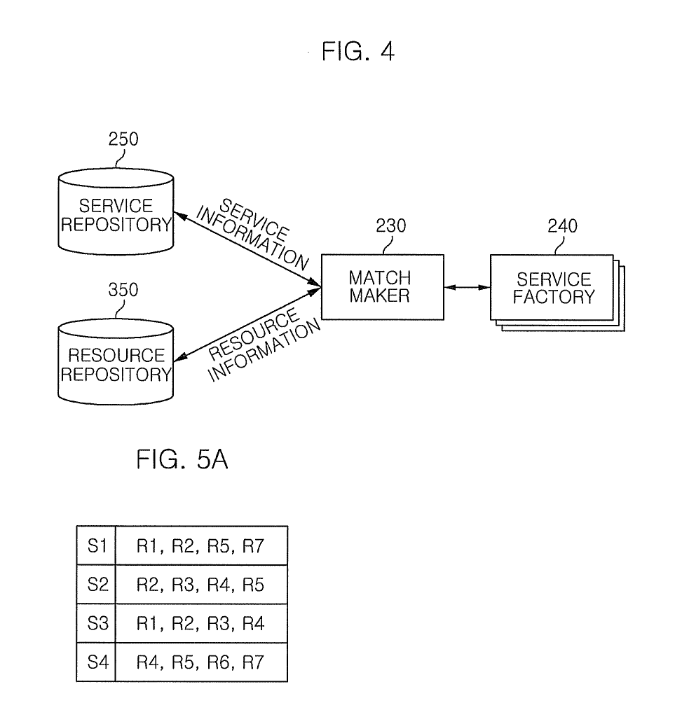

FIG. 4 is a diagram illustrating an operation of the match maker shown in FIG. 3. As shown in FIG. 4, the service repository 250 stores the service specification for all services provided by the system. The resource repository 350 stores the resource specification for all resources provided by the system. At this time, the match maker 230 receives a collection of resource identifiers to generate the service factory 240 for all the services which can be configured by the received resource collection. In this process, after the match maker 230 inquires the resource repository 350 through the collection of the received resource identifier and obtains the resource specification, the match maker 230 inquires the service repository 250 and finds out all combinable service types.

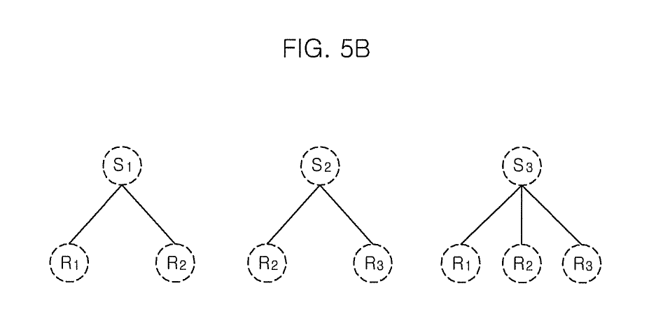

FIGS. 5A and 5B schematically illustrate a service model corresponding to a resource model according to an exemplary embodiment.

First, FIG. 5A illustrates resource information utilized for the corresponding service for each service type. That is, required resources for performing a service of a type corresponding to S1 are R1 and R2, an optional resource is R5, and a shared resource is R7. Further, required resources for performing a service of a type corresponding to S2 are R2 and R3, and optional resources are R4 and R5. Further, a required resource for performing a service of a type corresponding to S3 is R1, an optional resource is R3, and shared resources R2 and R4. Further, a required resource for performing a service of a type corresponding to S4 is R7, optional resources are R5 and R6, and a shared resource is R4.

Assuming that resources usable in the corresponding environment are R1, R2, and R3, a service supportable by using the corresponding resource is shown in FIG. 5B. That is, S1 can be supported by utilizing R1 and R2, and S2 can be supported by utilizing R2 and R3. Further. S3 can be supported by utilizing R1, R2, and R3.

Accordingly, when there is a request for a service type which can be used from the application A selected by the user, the usable service type information is provided to the application A. That is to say, the service manager 200 provides a list for the service models S1, S2, and S3 which are configured for each service type to the application A. Herein, the list for the service models, which are provided to the application A includes the information on the corresponding service type. If there is a request for a service for S1 from the application A, the service factory 240 corresponding to S1 is bound to R1 and R2 through the approach manager 320 of the resource manager 300 to generate the corresponding type service and provide the generated service to the application A.

At this time, in accordance with a request of the application A, the service manager 200 requests locking of R1 and R2, and the lock manager 330 of the resource manager 300 locks R1 and R2. Accordingly, if there is a request for generating the service for S2 from another application X, R2 has been already locked. Therefore, the approach manager 320 allocates only R3 to S2.

Meanwhile, the application X may request the application A to use the resource for R2. The application A may request the service manager 200 to unlock the resource R2 allocated to the available service. At this time, the service manager 200 requests the lock manager 330 of the service manager 300 to unlock R2 to allow the lock manager 330 to unlock R2. When R2 is unlocked, the application X may request the service manager 200 to allocate the resource R2. At this time, the lock manager 320 of the resource manager 300 unlocks the resource R2 allocated to S1 and allocates R2 to S2 again, such that the service factory 240 corresponding to S2 is bound to R2 and R3 through a connection manager of the resource manager 300 to generate the corresponding type service and provides the generated service to the application X.

Of course, the application A may not accept the request of the application X.

The above-configured operation of the exemplary embodiment of the present invention will now be described.

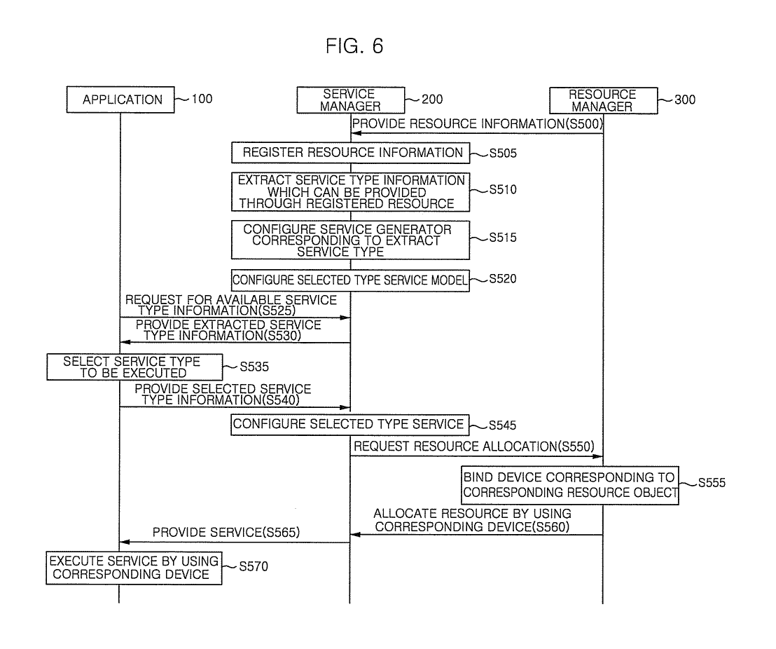

FIG. 6 is a flowchart for illustrating an operational flow with a service providing method in a pervasive computing environment according to an exemplary embodiment. Referring to FIG. 6, the resource manager 300 models all resources existing in the environment and provides the corresponding resource information to the service manager 200 (S500). In particular, the resource manager 300 provides the resource specification and the resource identifier for each resource model.

The service manager 200 registers the resource information provided from the resource manager 300 (S505). At this time, the service manager 200 extracts the service type information which can be provided by using the registered resource and configures the service factory 240 for each extracted service type (S510). Further, the service manager 200 models the service object for each service type extracted in S510 and registers the corresponding service model in the service container 210. At this time, each service model corresponds to the corresponding service factory 240.

Meanwhile, the application 100 selected by the user in the application hierarchy A requests type information on the available service to the service manager 200 (S525). At this time, the service manager 200 provides the service type information which can be provided by using the registered resource to the corresponding application 100 (S530). Herein, the type information on the available service is provided in the form of the list for the service model registered for each service type.

The corresponding application 100 selects any one service type to be executed based on the available service type information provided from the service manager 200 (S535) and provides the selected service type information to the service manager 200 (S540). The service manager 200 generates the corresponding type service through the service factory 240 corresponding to the selected service model (S545). Further, the service manager 200 requests the resource manager 300 to allocate the resource corresponding to the selected type service model (S545). The resource manager 300 binds the corresponding device corresponding from the resource model corresponding to the selected service model (S550) and allocates the device to the corresponding type service (S555). Of course, the logical resource may be bound according to the exemplary embodiment as well as the device.

Accordingly, the corresponding type service factory 240 provides the service to which the resource is allocated by the resource manager 300 to the corresponding application 100 (S565). The corresponding application 100 executes the service by using the device allocated to the corresponding service (S570).

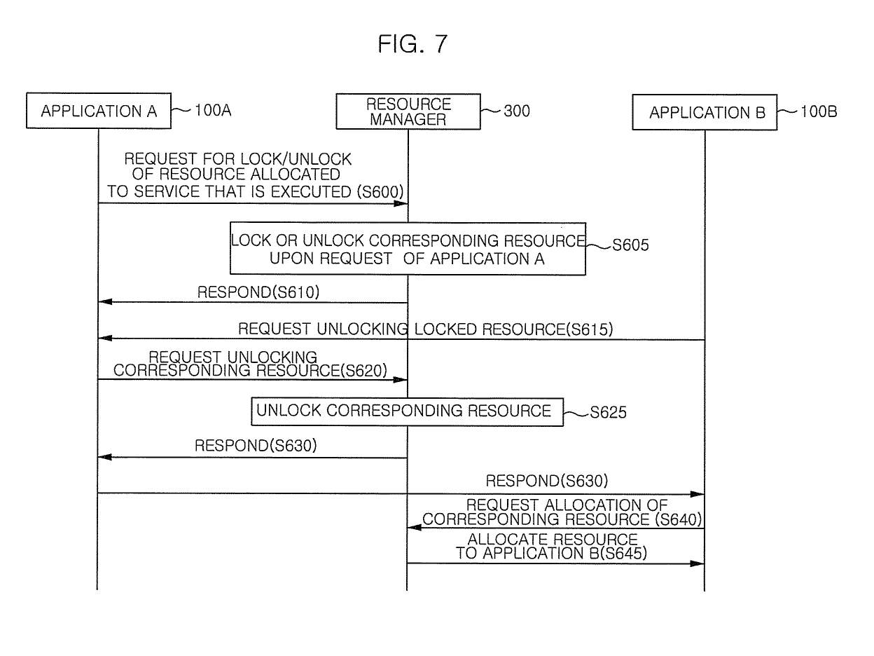

FIG. 7 is a flowchart of the flow of set-up and releasing operations of a locking function of a resource according to an exemplary embodiment of the present invention. Referring to FIG. 7, an application A 100A can request locking and unlocking of the resource allocated to the corresponding service in executing the service provided by the service manager 200 (S600). At this time, the request for the locking and unlocking is sent to the resource manager 300 through the service manager 200 and the resource manager 300 locks or unlocks the resource allocated to the corresponding service upon the request of the application A 100A (S605) and notifies the result to the application A 100A (S610).

When the resource of the corresponding service is locked upon the request of the application A 100A, an application B 100B requests the application A 100A to unlock the corresponding resource in order to use the locked resource (S615). Of course, the application A 100A may accept the request from the application B 100B in S615.

If the application A 100A accepts the request of the application B 100B, the application A 100A requests the resource manager 300 to unlock the corresponding resource through the service manager 200 (S620). Accordingly, the resource manager 300 unlocks the corresponding resource (S625) and notifies the result to the application A 100A (S630). Further, the application A 100A notifies the application B 100B of unlocking the corresponding resource (S635).

When the application B 100B requests the resource manager 300 to allocate the unlocked resource through the service manager 200 (S640), the resource manager 300 allocates the corresponding resource to the application B 100B to allow the application B 100B to execute the service by using the corresponding resource (S645).

Accordingly, the applications 100 can share the resource in the application hierarchy A. Further, it is possible to prevent the conflict of the resource by disabling the used resource to be allocated to the applications 100.

As described above, in a method for providing a service in a pervasive computing environment and an apparatus thereof according to exemplary embodiment of the present invention, the configuration and method of exemplary embodiments described as above cannot be limitatively applied, but all or some of the exemplary embodiments may selectively be combined and configured so that various modifications of the exemplary embodiments can be made.

What is claimed is:

1. A method for providing a service in a pervasive computing environment that is constituted by a resource manager, a service manager, and an application, the method comprising:
searching a resource usable in the corresponding computing environment and register the resource in the service manager by the resource manager;
receiving a request for allocation of a resource corresponding to a service model selected by the application from the service manager;
allocating the requested resource to a service configured based on the corresponding service model in receiving the request; and
locking or unlocking the allocated resource.

2. The method according to claim 1, wherein in locking or unlocking the resource, the resource manager locks the corresponding resource upon the request of the application that receives the service to which the resource is allocated in the allocating the request resource.

3. The method according to claim 1, wherein in the locking or unlocking the resource, the resource manager selectively locks or unlocks the resources allocated to the service.

4. The method according to claim 1, wherein in locking or unlocking the resource, when the resource allocated to the corresponding service is locked, the resource manager selectively unlocks the resource allocated to the corresponding service upon a request of another application.

5. The method according to claim 4, wherein the resource manager allocates the unlocked resource to a service requested by another application.

6. The method according to claim 1, further comprising:
configuring a resource model defined by the resource searched in the corresponding computing environment,
wherein information on the resource registered in the service manager includes identification information on the resource model.

7. The method according to claim 1, wherein the resource searched by the resource manager includes at least one of physical resources and logical resources that exist in the corresponding computing environment.

8. A method for providing a service in a pervasive computing environment that is constituted by a resource manager, a service manager, and an application, the method comprising:
extracting a service type which can be provided by using resource information searched by the resource manager in the corresponding environment and configure a service model having the extracted service type;
when a service model to be executed is selected by providing information on the service model to the application, configuring a service of a type corresponding to the selected service model; and
providing the service to the corresponding application by being allocated with a resource corresponding to the selected service model from the resource manager,
wherein the resource allocated in the providing the service is locked or unlocked by the resource manager.

9. The method according to claim 8, wherein the service model includes one or more resource information of a required resource required for executing the corresponding service, an optional resource which can be possessed by the corresponding service, and a shared resource of the corresponding service.

10. The method according to claim 9, further comprising:
before providing the service,
extracting the resource information from the selected service model; and
requesting the resource manager to allocate the corresponding resource on the basis of the extracted resource information.

11. An apparatus of providing a service in a pervasive computing environment that is constituted by a resource manager, a service manager and an application, wherein the resource manager includes
an approach manager that allocates a resource to the corresponding service upon a request for allocating a resource corresponding to a service model selected by the application from the service manager; and
a lock manager that locks or unlocks the resource allocated to the corresponding service by the approach manager.

12. The apparatus according to claim 11, wherein when there is a request for locking or unlocking a specific resource from the service manager, the lock manager locks or unlocks the corresponding resource.

13. The apparatus according to claim 11, wherein the resource manager further includes a resource container in which a resource model defined by the resource searched in the corresponding computing environment.

14. The apparatus according to claim 11, wherein the resource manager registers the resource information searched in the corresponding computing environment in the service manager.

15. The apparatus according to claim 14, wherein the resource information registered in the service manager includes identification information on the resource model defined by the resource searched in the corresponding computing environment.

16. The apparatus according to claim 13, wherein the resource model corresponds to one or more service model.

17. The apparatus according to claim 11, wherein the resource allocated to the service includes one or more resource of the physical resources and logical resource that exist in the corresponding computing environment.

18. The apparatus according to claim 11, wherein the service model includes one or more resource information of a required resource required for executing the corresponding service, an optional resource which can be possessed by the corresponding service, and a shared resource of the corresponding service.
